(19) United States
(12) Patent Application Publication
(10) Pub. No.: US 2007/0226503 A1
(43) Pub. Date: Sep. 27, 2007

(54) Music information providing apparatus and electronic music apparatus

(75) Inventors: Ryotaro Sugimoto, Shizuoka-shi (JP); Takeshi Ando, Hamamatsu-shi (JP); Seiji Abe, Hamamatsu-shi (JP); Shinya Sakurada, Hamamatsu-Shi (JP)

Correspondence Address: MORRISON & FOERSTER, LLP, 555 WEST FIFTH STREET, SUITE 3500, LOS ANGELES, CA, 90013-1024, US

(73) Assignee: Yamaha Corporation, Hamamatsu-Shi (JP)

(21) Appl. No.: 11/726,781

(22) Filed: Mar. 22, 2007

(30) Foreign Application Priority Data
Mar. 22, 2006 (JP) 2006-079103

(51) Int. Cl. H04L 9/00

(52) U.S. Cl. 713/172

(57) ABSTRACT

A music information providing apparatus comprises a connecting device that connects to a network, a memory that stores a plurality of information used on an electronic music apparatus, each information including at least a publication condition that permits or prohibits publication of the information and a condition relating to a right holder of the information, an authentication device that authenticates a user of the electronic music device accessing to the apparatus, and a providing device that provides the information stored in the memory to the authenticated user regardless of the publication condition when the authenticated user is a right holder of the information and provides the information only if the publication condition of the information permits publication to the user when the authenticated user is not a right holder of the information. Convenience of information sharing can be improved while protecting copyright of information.

### CROSS REFERENCE TO RELATED APPLICATION

This application is based on Japanese Patent Application 2006-079103, filed on Mar. 22, 2006, the entire contents of which are incorporated herein by reference.

### BACKGROUND OF THE INVENTION

A) Field of the Invention

This invention relates to a music information providing apparatus and an electronic music apparatus, and more in detail, relates to a music information providing apparatus that stores information to be used in the electronic music apparatus and the electronic music apparatus that can connect with the music information providing apparatus via a communication network.

B) Description of the Related Art

A system that data such as setting information and musical contents used on an electronic music apparatus such as an electronic musical instrument is stored in a server device and the electronic music apparatus can obtain the stored data by accessing to the server device. (For example, refer to the Japanese Laid-Open Patent 2002-372970.)

It has been supposed that a user of an electronic music apparatus stores own data by the user and obtains the stored data later only by the user in the conventional server device. It has not been considered that the data is opened to the public and that the user obtains data of a third party.

### SUMMARY OF THE INVENTION

It is an object of the present invention to provide a music information providing apparatus improves convenience of information sharing while protecting copyright of information.

Moreover, it is an object of the present invention to provide an electronic music apparatus that improves convenience of information sharing while protecting copyright of information.

According to one aspect of the present invention, there is provided a music information providing apparatus, comprising: a connecting device that connects to a network; a memory that stores a plurality of information used on an electronic music apparatus, each information including at least a publication condition that permits or prohibits publication of the information and a condition relating to a right holder of the information; an authentication device that authenticates a user of the electronic music device accessing to the music information providing apparatus via the network; and a providing device that provides the information stored in the memory to the electronic music device of the authenticated user regardless of the publication condition when the authenticated user is a right holder of the information and provides the information only if the publication condition of the information permits publication to the user when the authenticated user is not a right holder of the information.

According to another aspect of the present invention, there is provided an electronic music device, comprising: a connecting device that connects to a network; a memory that stores a plurality of information used on an electronic music apparatus, each information including at least a publication condition that permits or prohibits publication of the information and a condition relating to a right holder of the information; a transmitter that transmits the information via the network; and an automatic modifying device that automatically modifies the publication condition of the information not to permit publication before the transmitter transmits the information when a user is not a right holder of the information.

According to the present invention, a music information providing apparatus improves convenience of information sharing while protecting copyright of information can be provided.

According to the present invention, an electronic music apparatus that improves convenience of information sharing while protecting copyright of information can be provided.

### BRIEF DESCRIPTION OF THE DRAWINGS

FIG. 1 is a block diagram showing a structure of a music information sharing system 100 according to an embodiment of the present invention.

FIG. 2 is a block diagram showing a hardware structure of an electronic music apparatus 1 according to the embodiment of the present invention.

FIG. 3 is a schematic diagram showing attributes of user information stored in a user information storing unit 121 of the electronic music apparatus 1 according to the embodiment of the present invention.

FIG. 4 is a flow chart showing a downloading process of user information according to the embodiment of the present invention.

FIG. 5 is a schematic diagram showing an example of a folder screen FS according to the embodiment of the present invention.

FIG. 6 is a schematic diagram showing an example of an information list IL 1 according to the embodiment of the present invention.

FIG. 7 is a schematic diagram showing an example of an information list IL 2 according to the embodiment of the present invention.

FIG. 8 is a flow chart showing an uploading process of user information according to the embodiment of the present invention.

### DETAILED DESCRIPTION OF THE PREFERRED EMBODIMENTS

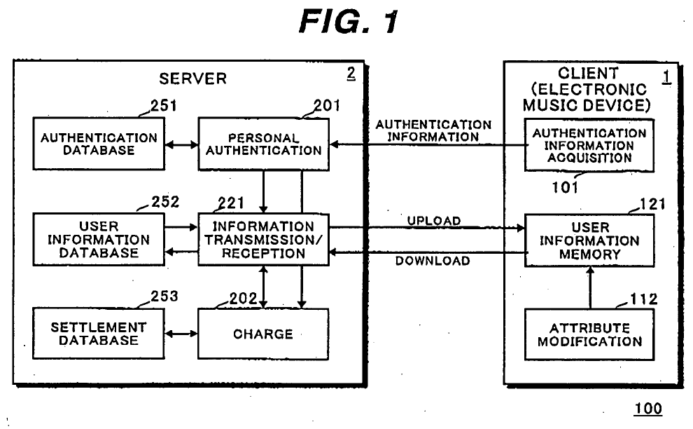

FIG. 1 is a block diagram showing a structure of a music information sharing system 100 according to an embodiment of the present invention.

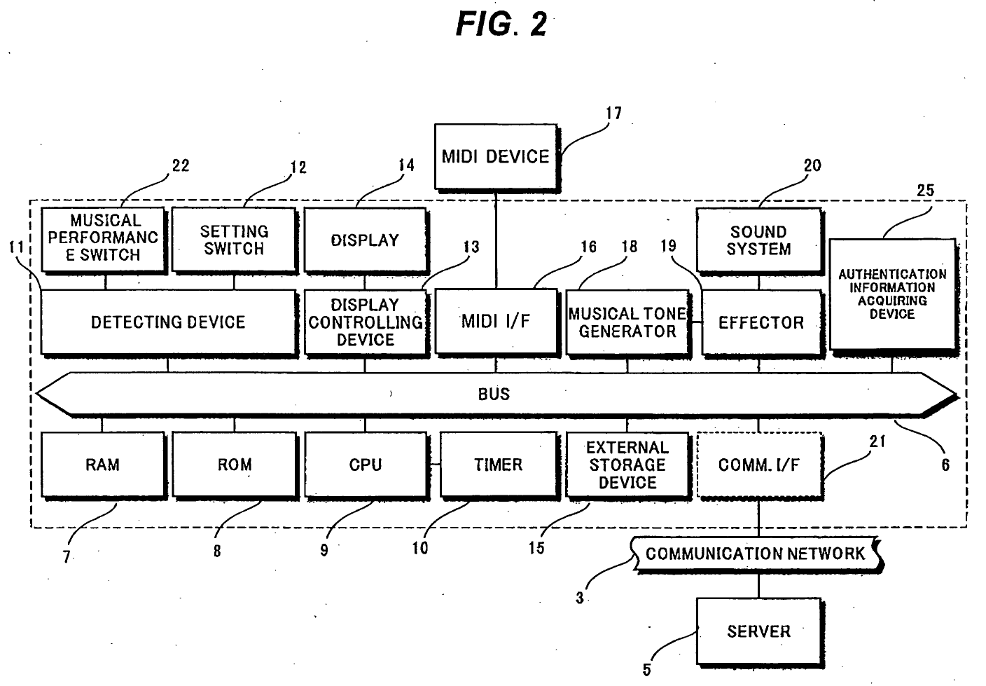

The music information sharing system 100 is consisted by connecting a music information providing apparatus (server) 2 with at least one electronic music apparatus (client terminal) 1 via a communication network (the Internet, etc.) 3 (FIG. 2).

The music information providing apparatus (server) 2 is composed of the server computer, etc. and has an authentication database 251, a user information database 252, and a settlement database 253. Moreover, the music information providing apparatus (server) 2 includes a personal authentication unit 201, an information receiving unit 221 and a charging unit 202.

The electronic music apparatus is a terminal that can connect with the communication networks 3 such as the electronic music apparatus such as the electronic musical instrument and the personal computer, and a terminal that can use the user information such as various music contents, device setting information and the like. Moreover, in this specification the phrase “user information” is not personal information of the user of the electronic music apparatus 1, but is setting information for automatically executing various settings (musical tone, volume, effect addition, accompanying style and the like) of the music contents that is data concerning to the music such as the music score (automatic performance data, digital music data and the like) and the electronic music apparatus 1.

The electronic music apparatus 1 includes, for example, an authentication information acquisition unit 101, a user information storing unit 121 and an attribute revision unit 112.

The authentication information acquisition unit 101 is composed of, for example, an authentication information acquisition device 25 (FIG. 2) such as an IC card reader, a finger print scanner, and acquires the authentication information for specifying the user to transmit the authentication information to the server 1 via the communication network 3. Moreover, the authentication information can be acquired by a biometric authentication technique or a token-based authentication technique, for example, any one or combination of information acquired by a living body (biometric) authentication technique such as a fingerprint, an iris (or retina), a voiceprint, a vein pattern and by a token-based authentication, so-called “something you have: SYH” authentication technique such as an IC card, a magnetic card, a USB key and the like can be used. Also, the authentication information acquisition device 25 is equipped with a function that can read or scan the authentication information corresponding to the kind of the authentication information to be adopted. Moreover, as the authentication information, a combination of the user ID and the password can be used independently or can be used with the above combination of the biometric-based authentication information and the token-based authentication information. Also, the unique device identification information of the electronic music apparatus 1 and the identification information (media ID) of the storing device can be combined to use as the authentication information.

The personal authentication unit 201 of the server 2 receives the authentication information transmitted from the authentication information acquisition unit 101 of the electronic music apparatus 1 and executes personal authentication by collating the received authentication information with the authentication information stored in the authentication database 251. In the authentication database 251, the personal information of the user and the authentication information are stored by correlating with each other. After the successful completion of the personal authentication in the personal authentication unit 201, the user will be able to execute transmission and reception (downloading and uploading) of the information.

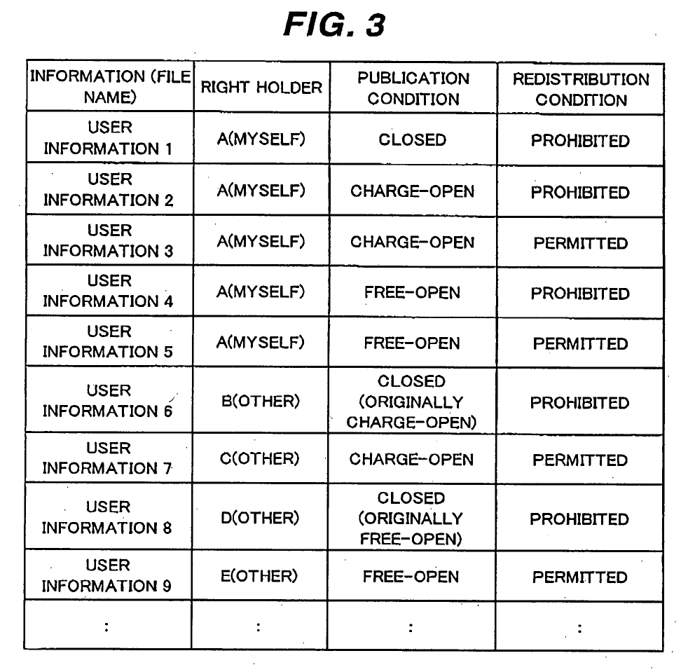

In the user information storing unit 121 of the electronic music apparatus 1, user information created by the user, user information downloaded before and user information acquired in other way are stored. In each one of user information, the attribute information described later with reference to FIG. 3 are stored. As attribute of information, for example, there are a publication attribute for regulating publication policy of the information whether the information is open to a public without any charges (hereinafter called “free-open”) or with a charge (hereinafter called “charged-open”) or is closed to a public (hereinafter called just “closed”), and a redistribution attribute for regulating redistribution policy of the information whether redistribution of the information is “permitted” or “prohibited”, etc. The user information storing unit 121 can upload (transmit) the user information selected by the user to the server 2 via the communication network 3. Moreover, the user information of which the redistribution attribute is “permitted” cannot be uploaded to the server 2. Also, the user information selected by the user can be downloaded (received) from the server 2 via the communication network 3 and stored in the information storing unit 121. Moreover, when the user uploads the user information to the server 2, the user can revise some or all of the attributes of the user information by the attribute revision unit 112. For example, the publication attribute of the user information may be revised to free-open, charged-open or closed. Moreover, it is preferable to prohibit the revision of some or all of the attributes of the user information if that user information is not created by that user by herself/himself for protecting a copy right of other user.

The information transmitting and receiving unit 221 of the server 2 receives the user information transmitted from the user information storing unit 121 of the electronic music apparatus 1 and stores the received user information into the user information database 252 with correlating the received user information with the personal information (authentication information or an identifier that can specify the user) of the user obtained from the personal authentication unit 201. The user information stored in the user information database 252 can be freely browsed and used by the user who has uploaded the information. By doing that, if the electronic music apparatus 1 can access with the server 2, the registered user information (the user information stored in the server 2) can be used regardless of a location of the electronic music apparatus 1. For example, when the user is borrowing an apparatus (the electronic music apparatus 1) belonging to other user, the user can use the user information by accessing to the server 2 with the apparatus. Moreover, when the user has revised the publication attribute to the free-open, the user information can be used by other users by free of charge. Moreover, when the user has revised the publication attribute to the charged-open, other user can use the user information only by paying a charge.

The information transmitting and receiving unit 221 of the server 2 reads the user information selected by the user from the user information database 252 in accordance with a downloading request by the user and transmits the read user information to the electronic music apparatus 1 via the communication network 3. The user can freely (without a charge) use the user information registered by that user before and the user information of other user of which publication attribute is free-open. When the user information that the user requested to download is the user information of other user and its publication attribute is the charged-open, a charging process for charging the user for a predetermined charge is executed by the charging unit 202. The charging unit 202 charges the predetermined charge to the user who has downloaded the user information with reference to the settlement database 253 based on the personal information (the authentication information or the identifier that can specify the user) of the user acquired from the personal authentication unit 201. At the same time, at least a portion of the predetermined amount of charge to the user who downloaded the user information will be distributed to a rightful owner (a copyright holder) of the downloaded user information. The distribution of the charging amount is, for example, based on the personal information (the authentication information or the identifier that can specify the user) included in the user information to be downloaded, and is executed to an account of the user represented in the personal information with reference to the settlement database 253. The settlement database 253 is a database to register the account information for executing the charging or distribution process to each user. The charging and the distributing processes to each user are executed by using settlement means that can settle the charge on the communication network such as a credit card and an IC card.

FIG. 2 is a block diagram showing a hardware structure of the electronic music apparatus 1 according to the embodiment of the present invention.

A RAM 7, a ROM 8, a CPU 9, an external storing device 15, a detector 11, a displaying circuit 13, a communication interface (I/F) 21, an authentication information acquiring device 25 are connected to the bus 6 of the electronic music apparatus 1.

The RAM 7 has a working area of the CPU 9, the working storing a buffer region, a flag, a register and various parameters.

Various parameters and a controlling program or a program for realizing the embodiment of the present invention can be stored in the ROM 8. In this case, the program, etc. do not have to be duplicately stored in the external storage device 15.

The CPU 9 executes calculations and controls the electronic music apparatus 1 in accordance with the controlling program, etc. stored in the ROM 8 or in the external storing device 15. A timer 10 is connected to the CPU 9 and provides a standard clock signal and an interrupt timing to the CPU 9.

The user can input and execute various settings and selections by using an inputting switch 12 connected with the detector 11. The inputting switch 12 is an operator that can at least output a signal corresponding to an input operation by the user, such as an alpha-numeric keyboard, a mouse, a switch, a pad, a fader, a slider, a rotally encoder, a joy-stick, a jog-shuttle and the like. Moreover, the inputting switch 12 may be a software switch displayed on the display 14 and may be operated by using other switch such as a pointing device like the mouse.

The displaying circuit 13 is connected with the display 14, and various information can be displayed on the display 14. The user inputs and executes various settings with reference to the information displayed on the display 14. Moreover, the display 14 may be an external displaying device.

The user information shown in FIG. 3 is stored in the external storing device 15. The external storing device 15 includes an interface for the external storing device and is connected with the bus 6 via the interface. The external storing device 15 is, for example, a flexible disk or a floppy™ disk drive, a hard disc drive (HDD), a magneto-optical disk (MO) drive, a CD-ROM (compact disc read only memory) drive, a DVD (Digital Versatile Disc) drive, a semiconductor memory and the likes.

When the hard disk drive (HDD) is connected as the external storing device, the controlling program, etc. for realizing the embodiment of the present invention can be stored in the hard disk drive (HDD). By reading the controlling program, etc. from the hard disk drive to the RAM 7, the same operation as in a case that the controlling program, etc. are stored in the ROM 8 can be executed by the CPU 9. By doing that, addition of the controlling program, etc. and version-up can be executed easily.

When the CD-ROM drive is connected in addition to the hard disk drive, the controlling program and the program, etc. for realizing the embodiment of the present invention can be stored in the CD-ROM. The controlling program and the program, etc. for realizing the embodiment can be installed from the CD-ROM to the hard disk. New install and version-up of the controlling program, etc. can be executed easily in that case.

The MIDI interface (MIDI I/F) 16 can be connected with a MIDI device 17, other musical instrument, an audio device, a computer, etc. and can at least transmit and receive a MIDI signal.

The MIDI device 17 is an audio device, a musical instrument, etc. to be connected with the MIDI interface 16.

A musical tone generator 18 generates a musical tone signal corresponding to accompanying pattern data, performance data stored in the external storing device 15, the ROM 8 or the RAM 7, and a performance signal or a MIDI signal provided from the MIDI device 17 connected to the MIDI interface 16. The musical tone generator 18 provides the generated musical tone signal to a sound system 20 via an effecter circuit 19.

The effecter circuit 19 adds various musical effects to the musical tone signal provided from the musical tone generator 18. The sound system 20 includes a D/A converter and a loudspeaker or loudspeakers, and converts the provided digital musical tone signal to an analogue signal to pronounce.

The communication interface 21 can be connected with the communication network 3 such as a local area network (LAN) and the Internet and can be connected with the server 2 and other electronic music device 1 each other via the communication network 3.

The communication Interface 21 and the communication network 3 can be wired or wireless. Also, both wired and wireless communication interface and the communication network 3 may be equipped. The communication interface 21 is not limited to a built-in type, but may be a removable type such as a PC card, etc.

The performance switch 22 is connected with the detector circuit 11 and provides performance information in accordance with a musical performance operation of the user. As the performance switch 22, a musical keyboard for a musical performance and a pad can be used. Moreover, the performance switch 22 is not limited to the above, and may be anything with which the user can input musical performance information.

The authentication information acquiring device 25 is a device that can acquire the authenticating information for specifying the user. For example, it is a reader or scanner that can read or scan at least one of a living body authentication (biometric) information (a fingerprint, an iris (or retina), a voiceprint, a vein pattern) and token-based authentication information (an IC card, a magnetic card, a USB key, etc.). Moreover, when only a combination of the user ID and the password is used as the authentication information, the authentication information acquiring device 25 can be omitted.

The server 2 can be realized by executing a software program for realizing the embodiment of the present invention by a commonly used computer. Also, it can be realized by the same structure as the above-described electronic music apparatus 1. In this case, unnecessary structure can be properly omitted. For example, the MIDI interface (MIDI I/F) 16, the musical tone generator 18, the effecter circuit 19, the sound system 20, the performance switch 22, the authentication information acquiring device 25, etc. may be omitted.

FIG. 3 is a schematic diagram showing attributes of the user information stored in a user information storing unit 121 of the electronic music apparatus 1 according to the embodiment of the present invention.

As shown in the drawing, a file name (the user information 1 to n), a right holder, the publication attribute, the redistribution attribute are stored in each one of the user information (1 to n) in addition to the substantial content (at least one of automatic performance data, music data, music score data, device setting information, etc.) corresponding to each file type.

The right holder is, for example, a copyright holder of the information or a producer of the information without the copyright, and at least has a right concerning to publication and distribution of the information. In the drawing, “A” represents that the user of the electronic music apparatus 1 is the right holder of the user information stored in the user information storing unit 121 of the electronic music apparatus 1, and other “B” to “E” represent a case that the user is not the right holder.

The user can set the publication attribute of the user information for which the user is the right holder to “closed”, “charged-open”, and “free-open” arbitrary. The “closed” is the attribute that only the user who is the right holder can browse and download even if registered (uploaded) to the server 2. The “charged-open” is the attribute that other user can browse and download if a predetermined charge is paid. The right holder can browse and download own user information with the “charged-open” attribute with free of charge. The “free open” is the attribute that all users can browse and download with free of charge. Moreover, it can be set whether the other user (non-right holder) is permitted to re-upload to the server 2 and publicize the information to the third party as the redistribution attribute of “permitted” or “prohibited” when the other user (non-right holder) downloads the information with the publication attribute of “free-open” or “charged-open”.

When the redistribution attribute is “prohibited” (for example, the user information 1, 2, 4, 6 and 8 in the drawing), the publication attribute of the user information downloaded by other user (non-right holder) is automatically set (revised) to “closed”. By that, even if the user information of which the redistribution attribute is “prohibited” is downloaded, other user can upload the information to the server 2 as far as the other user downloads the information for private usage, that is, a user who downloads the user information with the redistribution attribute of “prohibited” can upload the information again to the server 2 with the publication attribute of “closed”, and only the user who successfully uploads the user information can download the uploaded user information with the “closed” publication attribute.

For example, when the user of the electronic music apparatus 1 downloads the user information having the attribute of “open” as the publication attribute that other user is the right holder, the publication attribute is automatically revised to “closed”, and the redistribution attribute is also revised to “prohibited” (for example, as shown in the user information 8 in the drawing). By that, the right of other user (a right holder) can be protected.

Moreover, when the redistribution attribute is “permitted” (for example, the user information 3, 5, 7 and 9 in the drawing), other user who downloaded that kind of the user information can re-upload the user information with the “open” publication attribute. By that, a right holder of the user information can widely distribute the user information produced by the right holder. For example, when the publication attribute of the user information is “charged open” (for example, the user information 3 and 7 in the drawing), the right holder can expect dividend from the information with the “charged-open” attribute unlike the information with the “closed” or “free-open” publication attribute.

The user can arbitrary revise or modify the contents and the attributes of the user information to which the user has a right (for example, the user information 1 to 5 in the drawing). For example, the content data in the way of producing can be once uploaded with the “closed” publication attribute, and it can be revised to the “open” publication attribute after the completion of the production of the content data. On the other hand, regarding to the user information to which someone has a right (for example, the user information 6 to 9 in the drawing), the content and the attributes of the user information cannot be revised except the automatic revision. However, if “revising attribute” for regulating revision of the information by a user other than a right holder of the information is included in the attributes of the information and is “revisable”, the information can be revised within the authorization of the “revising attribute”, that is, the user who is not an owner (right holder) of the information can revise a part of the information of which “revising attribute” is “revisable”.

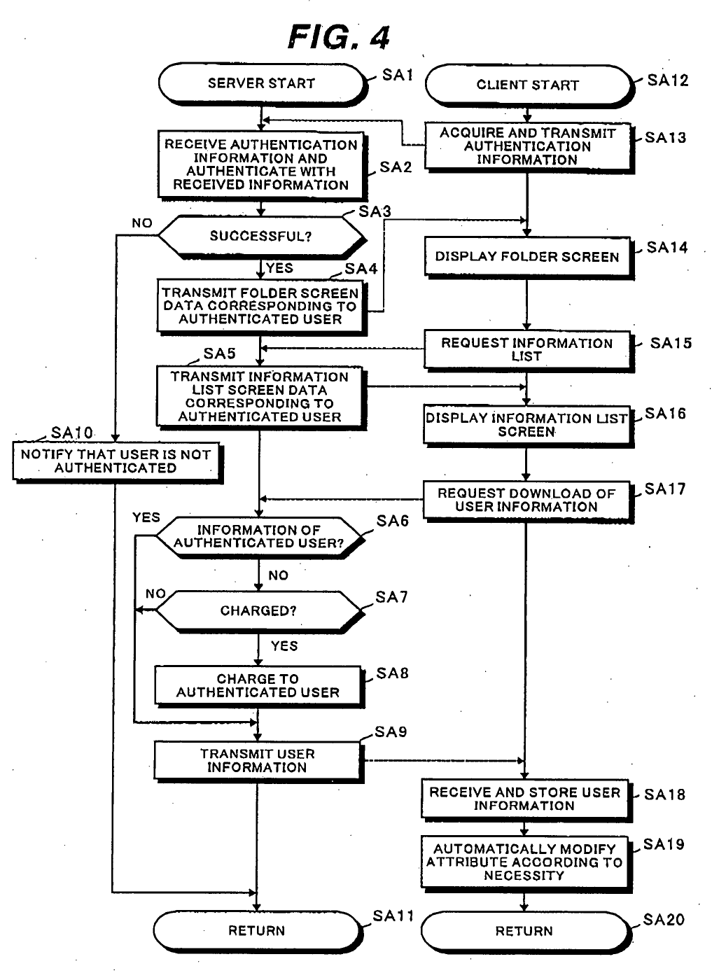

FIG. 4 is a flow chart showing downloading process of user information according to the embodiment of the present invention. In the drawing, Steps SA1 to SA11 are the processes on the server 2, and Steps SA12 to SA20 are the processes on the client (the electronic music apparatus) 1. Moreover, a dotted arrow in the drawing represents a data flow via the communication network 3 (FIG. 2).

At Step SA1, the process on the server 2 is started, and at Step SA2, the authentication information transmitted from the client 1 at the later-described Step SA13 is received via the communication network 3. The personal authentication of the user is executed by, for example, collating with the information in the authentication database 251 as explained with reference to FIG. 1. Thereafter, at Step SA3, the authentication result at Step SA2 is judged. When the authentication at Step SA2 is succeeded (when the received authentication information is agreed with one of the information in the authentication database 251), the process proceeds to Step SA4 as indicated with an arrow “YES”. When the authentication is not succeeded, the process proceeds to Step SA10 as indicated with an arrow “NO” to notify that the authentication is not succeeded to the client 1 (the user). Then, the process proceeds to Step SA11 to finish the process at the server 2.

At Step SA4, a folder screen data corresponding to the authenticated user is generated and transmitted to the client 1 via the communication network 3.

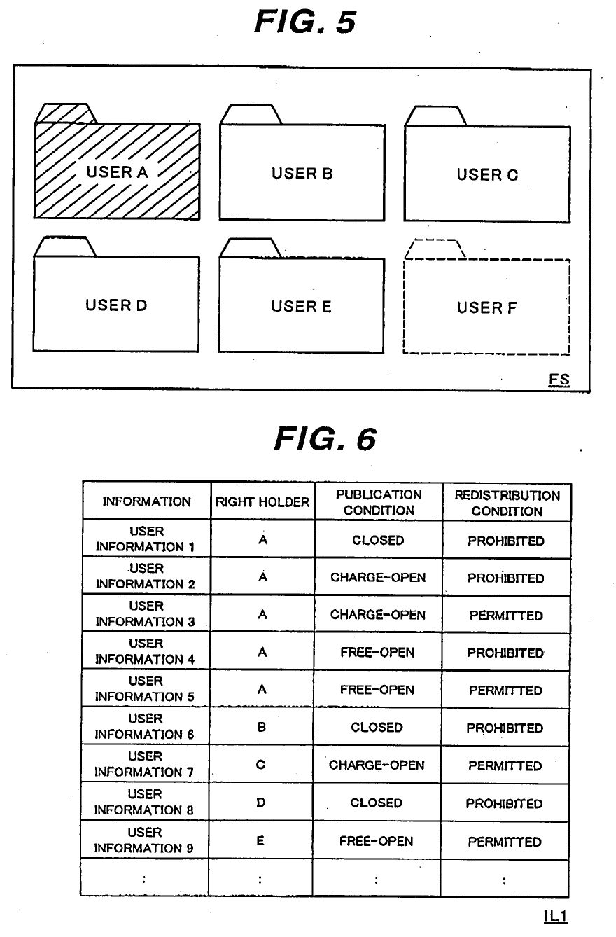

Moreover, the folder screen data is, for example, data for displaying a folder screen FS shown in FIG. 5 on the display 14 (FIG. 2) of the client 1.

A folder corresponding to the user registered in the server 2 is displayed on the folder screen FS. In this example, the folder screen FS to be transmitted when a user A accesses to the server 2 and the authentication is successfully completed is represented. The folder (the folder where the user information uploaded by the user A is stored) corresponding to the authenticated user A is displayed with an emphasis comparing to other folders. Moreover, for example, a folder of a user F is displayed less attractively (with a dotted line in the drawing) than other folders; however, it is indicated that all the user information registered by the user F have the publication attribute of “closed”. Moreover, although when all the registered user information have the publication attribute of “closed”, the folder is displayed less attractively in this example, that kind of folder may be blind from other users. Moreover, although the own folder may be displayed with emphasis in this example, types of the emphasizing display may be anything that can distinguish the own folder from other folder. Also, in this example, folder icons are displayed, a simple text-based list of the folders may be displayed, and folders may be displayed by other displaying types.

At Step SA5, the user information corresponding to the authenticated user and the information corresponding to other user is, for example, extracted from the user information database 252 in FIG. 1 to transmit the information list screen data for displaying the extracted user information by a list to the client 1 via the communication network 3 corresponding to the information list request transmitted from the client 1.

The information list to be transmitted to the client is different according to a type of the information list (for the own folder or other user's folder) requested from the client 1 by the later-described request for transmission of the information list at Step SA15.

FIG. 6 is a schematic diagram showing an example of an information list IL 1 according to the embodiment of the present invention. This information list IL 1 is transmitted from the server 2 to the client 1 in response to a browsing request of the folder storing the user information registered by that user. In detail, it is an example of a case that the user authenticated as the user A browses the folder of the user A. Since the user A is a person who has registered (uploaded) the information, the user A can browse all the user information stored in the folder (of the user A). The desired user information is selected with one or plurality of switches to instruct downloading of the selected information, and the selected user information can be downloaded from the server 2 to the client via the communication network 3.

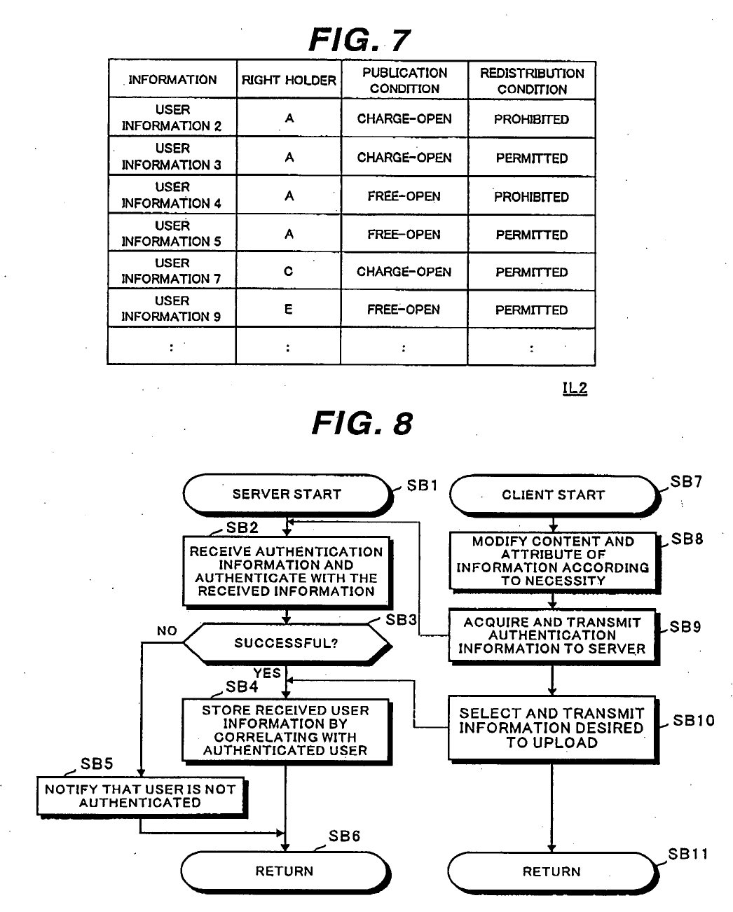

FIG. 7 is a schematic diagram showing an example of an information list IL 2 according to the embodiment of the present invention. This information list IL 2 is transmitted from the server 2 to the client 1 in response to a request for browsing the folder storing the user information registered by other user. In detail, it is an example of a case that the user authenticated as one of the users B to F browses the folder of the user A.

When one of the users B to F browses the folder contents of the user A, only the information of which publication attribute is not “closed” but “charged open” or “free open” is displayed clearly (or with emphasis) comparing to the information list IL 1 shown in FIG. 6. In this case, one or plurality of desired user information are selected from the displayed user information with an operation of the switch to instruct downloading the selected information, and the selected user information can be downloaded from the server 2 to the client 1 via the communication network 3. Moreover, a predetermined usage fee is charged for the user information of “charged open” at the later-described Step SA8.

Back to FIG. 4, at Step SA6, it is judged whether the user information that is a target of the downloading request to be transmitted at the later-described Step SA17 (hereinafter called just “the target user information”) is the information to which the user authenticated at Step SA2 has a right or not. This is executed by extracting the user information that is the target of the downloading request from the user information database 252 and collating a right holder recorded in the extracted user information with the personal information of the user authenticated at Step SA2. When the user information that is the target of the downloading request is the information of the authenticated user, the process proceeds to Step SA9 as indicated with an arrow “YES”, and the process proceeds to Step SA7 as indicated with an arrow “NO” in other case.

At Step SA7, it is judged whether the publication attribute of the target user information is “charged open” or not. This is executed by extracting the user information that is the target of the downloading request from the user information database 252 and confirming the publication attribute recorded in the extracted user information. When the publication attribute is “charged open”, the process proceeds to Step SA8 as indicated with an arrow “YES”, and the process proceeds to Step SA9 as indicated with an arrow “NO” in other case.

At Step SA8, a price for the download of the target user is charged to the authenticated user. This charging process, for example, charges a predetermined price to the user who has downloaded the user information with reference to the settlement database 253 based on the personal information (the authentication information and/or the identifier that can specify the user) of the user at Step SA2 as explained with reference to FIG. 1. At the same time, at least a portion of the charged price to the user who downloaded the user information is distributed to an owner (a copyright holder) of the downloaded user information. Moreover, any other well-known technique can be used for the charging process.

At Step SA9, the target user information is read from the user information database 252 to transmit to the client 1 via the communication network 3. Thereafter, the process proceeds to Step SA11 to finish the process on the server 2.

At Step SA12, the process on the client 1 is started, and at Step SA13, the authentication information is acquired to transmit to the server 2 via the communication network 3. Acquiring of the authentication information is executed, for example, by using the authentication information acquiring device 25 as explained with reference to FIG. 1 and FIG. 2.

At Step SA14, the folder screen data to be transmitted from the server 2 at Step SA4 is received, and for example, the folder screen FS shown in FIG. 15 is displayed on the display 14 in FIG. 2 based on the received data.

At Step SA15, the information list IL1 (or IL′) of the user information stored in the folder corresponding to each user selected by the user using the switch 12 with reference to the folder screen FS displayed on the screen 14 is requested to the server 2 (i.e., transmitting the request for transmission of the information list to the server 2).

At Step SA16, the information list IL1 (or IL2) transmitted from the server 2 at Step SA5 is received to display the list on the display 14. When the user selects the own folder at Step SA15, the received and displayed information list t is corresponding to the information list IL1, and when the user selects the user folder of other user, the information list is corresponding to the information list IL2.

At Step SA17, one or plurality o the user information to be downloaded is/are selected with reference to the information list IL1 (or IL2) displayed on the display 14, and the download request of the selected user information is transmitted to the server 2.

At Step SA18, the user information transmitted from the server 2 at Step SA9 is received and stored into, for example, the external storing device 15.

At Step SA19, the attribute of the user information received and stored at Step SA18 is automatically revised corresponding to necessity. The target of the automatic revision is, for example, the user information to which other person has a right and of which the redistribution attribute is “prohibited”. In this case, the attribute of the publication attribute is automatically revised to “closed”. Thereafter, the process proceeds to Step SA20 to finish the process on the client 1.

Moreover, although the automatic revision of the attribute is executed at Step SA19 on the client 1 in the embodiment of the present invention, the attribute may be revised on the server 2 before the transmitting process at Step SA9.

FIG. 8 is a flow chart showing an uploading process of user information according to the embodiment of the present invention. In the drawing, Step SB1 to Step SB6 are the processes on the server 2, and Step SB7 to Step SB11 are the processes on the client (electronic music apparatus) 1. Also, a dotted line arrow in the drawing represents the data flow via the communication network 3 (FIG. 2).

Since processes at Step SB1 to Step SB3 and Step S85 on the server 2 are the same processes as at Step SA1 to Step SA3 and Step SA10 in FIG. 4, the explanations for those will be omitted.

After the successful completion of user authentication, at Step SB4, the user information transmitted from the client 1 at the later-described Step SB10 via the communication network 3 is received, and the received user information is registered (stored), for example, in the user information database 252 in FIG. 1 by correlating to the authenticated user. Thereafter, the process proceeds to Step SB6 to finish the process on the server 2.

At Step SB7, the process on the client 1 starts, and at Step SB8, contents and attribute of arbitral user information stored in the client 1 are modified according to necessity. Moreover, new user information may be created.

At Step SB9, the authentication information is acquired and transmitted to the server 2 via the communication network 3. For example, the acquisition of the authentication information is executed by using the authentication information acquisition device 25 as explained with reference to FIG. 1 and FIG. 2.

At Step SB10, the user information to be uploaded is selected and transmitted to the server 2 via the communication network 3. Thereafter, the process proceeds to Step SB11 to finish the process on the client 1.

As described in the above, according to the embodiment of the present invention, the server 2 stores publicized (open-to-public) or unpublicized (closed-to-public) user information for later use on the electronic music apparatus 1 for each user, and the provision of the user information can be controlled in the manners such as providing both of the publicized and unpublicized user information to all of the accessed users and providing only the publicized user information to all of the accessed users. By that, the user's own convenience can be secured and the protection of a right to the information can be secured at the same time.

Moreover, according to the embodiment of the present invention, the user information to be publicized on the server 2 can be defined as the “free open” or the “charged open”. In the case of the charged open, it can be determined whether the charging process is executed or not according to a right holding status (having a right to the information or not) of the accessed user.

Moreover, according to the embodiment of the present invention, when the user information is transmitted to the server 2, the electronic music apparatus 1 transmits the user information with the “closed” publication attribute to the server 2 in a case that the user information is owned by other user (i.e., the user downloading and uploading the information has no right to the information). By that, the protection of the information for the other user (a right holder) can be surely secured.

Moreover, although in the above-described embodiment of the present invention the automatic revision of the attribute on the electronic music apparatus 1 is executed when the user information is downloaded, it may be executed when the user information is uploaded to the server 2 or at any arbitral timing from downloading to uploading.

Moreover, although when the user information is downloaded at the electronic music apparatus 1, the publication attribute of the uploading user information is determined based on both of a right holder and the redistribution attribute of the uploading information in the above-described embodiment of the present invention, the publication attribute may be automatically revised based on either one of the right holder and the attribute. That is, when the user information is the user information of others, the publication attribute of the user information can be unconditionally changed to “closed”, or it may be determined whether the publication attribute of the user information is “open” or “closed” based only on the redistribution attribute regardless of the owner (right holder) of the information.

The present invention has been described in connection with the preferred embodiments. The invention is not limited only to the above embodiments. It is apparent that various modifications, improvements, combinations, and the like can be made by those skilled in the art.

What are claimed are:

1. A music information providing apparatus, comprising:
a connecting device that connects to a network;
a memory that stores a plurality of information used on an electronic music apparatus, each information including at least a publication condition that permits or prohibits publication of the information and a condition relating to a right holder of the information;
an authentication device that authenticates a user of the electronic music device accessing to the music information providing apparatus via the network; and
a providing device that provides the information stored in the memory to the electronic music device of the authenticated user regardless of the publication condition when the authenticated user is a right holder of the information and provides the information only if the publication condition of the information permits publication to the user when the authenticated user is not a right holder of the information.

2. The music information providing apparatus according to claim 1, wherein the publication condition permits the publication of the information with free of charge or with a predetermined amount of charge when the publication condition permits the publication, and
the music information providing apparatus further comprising a charging device that charges the authenticated user for a price of providing the information when the publication condition of the information permits publication of the information with a predetermined charge and the user is not a right holder of the information.

3. The music information providing apparatus according to claim 1, further comprising a receiving device that receives information on an electronic music apparatus uploaded from the electronic music device by the user and stores the received information to the memory, and wherein
the user who has uploaded the information is permitted to download the uploaded information regardless of the publication condition and a right holder of the information.

4. The music information providing apparatus according to claim 1, wherein the information used on an electronic music device is music data.

5. The music information providing apparatus according to claim 1, wherein the information used on an electronic music device is musical score data.

6. The music information providing apparatus according to claim 1, wherein the information used on an electronic music device is setting information of the electronic music device.

7. The music information providing apparatus according to claim 1, wherein the authentication device uses a biometric technique for authenticating a user of the electronic music device accessing to the music information apparatus via the network.

8. The music information providing apparatus according to claim 1, wherein the authentication device uses a token-based authentication technique for authenticating a user of the electronic music device accessing to the music information apparatus via the network.

9. An electronic music device, comprising:
a connecting device that connects to a network;
a memory that stores a plurality of information used on an electronic music apparatus, each information including at least a publication condition that permits or prohibits publication of the information and a condition relating to a right holder of the information;
a transmitter that transmits the information via the network; and
an automatic modifying device that automatically modifies the publication condition of the information not to permit publication before the transmitter transmits the information when a user is not a right holder of the information.

10. The electronic music device according to claim 9, wherein
the information used on an electronic music device further includes a redistribution condition that permits or prohibits redistribution of the information, and
the automatic modifying device automatically modifies the publication condition of the information not to permit publication before the transmitter transmits the information when a user is not a right holder of the information and the redistribution condition prohibits redistribution of the information and does not modify the publication condition of the information when the redistribution condition permits redistribution of the information.

11. The electronic music device according to claim 9, further comprising an editing device that edits the information stored in the memory of the electronic music device, and wherein the editing device cannot edit the information when the user of the electronic music device is not a right holder of the information.

12. The electronic music device according to claim 9, wherein the information used on an electronic music device is music data.

13. The electronic music device according to claim 9, wherein the information used on an electronic music device is musical score data.

14. The electronic music device according to claim 9, wherein the information used on an electronic music device is setting information of the electronic music device.

15. The electronic music device according to claim 9, wherein the authentication device uses a biometric technique for authenticating a user of the electronic music device accessing to the music information apparatus via the network.

16. The electronic music device according to claim 9, wherein the authentication device uses a token-based authentication technique for authenticating a user of the electronic music device accessing to the music information apparatus via the network.

17. A program executed by a server computer comprising a memory that stores a plurality of information used on an electronic music apparatus, each information including at least a publication condition that permits or prohibits publication of the information and a condition relating to a right holder of the information, the program comprising the instructions for:
connecting to a network;
authenticating a user accessing to the server via the network; and
providing the information stored in the memory to the electronic music device of the authenticated user regardless of the publication condition when the authenticated user is a right holder of the information and provides the information only if the publication condition of the information permits publication to the user when the authenticated user is not a right holder of the information.

18. A program executed by an electronic music device comprising a memory that stores a plurality of information used on an electronic music apparatus, each information including at least a publication condition that permits or prohibits publication of the information and a condition relating to a right holder of the information, the program comprising the instructions for:
connecting to a network;
transmitting the information via the network; and
automatically modifying the publication condition of the information not to permit publication before the transmitter transmits the information when a user is not a right holder of the information.
